(19) United States
(12) Patent Application Publication
(10) Pub. No.: US 2025/0283009 A1
(43) Pub. Date: Sep. 11, 2025

(54) OLEAGINOUS MATERIAL EXTRACTION WITH SEPARATION DEVICE TO RECOVER AND SUPPLEMENT FRESH SOLVENT FLOW

(71) Applicant: Crown Iron Works Company LLC, Blaine, MN (US)

(72) Inventors: Wade Steven Martinson, Minneapolis, MN (US); Revathi Panuganti, Minneapolis, MN (US); Nicholas Ollila, Fridley, MN (US); Benjamin Wayne Floan, Andover, MN (US)

(21) Appl. No.: 19/076,816

(22) Filed: Mar. 11, 2025

Related U.S. Application Data
(60) Provisional application No. 63/563,943, filed on Mar. 11, 2024.

(51) Int. Cl. C11B 1/10

(52) U.S. Cl. CPC C11B 1/10

(57) ABSTRACT

A solvent extraction process may be used to generate a miscella stream. The miscella stream may be processed by a separation device, such as a decanter, to form a light phase stream and a heavy phase stream. In some examples, a portion or all of the light phase recycle stream passes to a solvent purification device, such as a membrane, that separates the feed stream into a purified solvent stream and a concentrated light phase stream. The purified solvent stream may be solvent that is substantially or completely free of oil. The concentrated light phase stream contains a portion of the solvent from the feed stream together with nearly all or all of the oil in the feed stream. The purified solvent stream can then be used to supplement the fresh solvent feed to the extractor.

### CROSS-REFERENCE

This application claims the benefit of United Stated Provisional Patent Application No. 63/563,943, filed Mar. 11, 2024, the entire contents of which are incorporated herein by reference.

### TECHNICAL FIELD

This disclosure relates to solvent extraction and, more particularly to liquid-solvent extraction using an alcohol-based solvent.

### BACKGROUND

A variety of different industries use extractors to extract and recover liquid substances entrained within solids. For example, producers of oil from renewable organic sources use extractors to extract oil from oleaginous matter, such as soybeans, rapeseed, sunflower seed, peanuts, cottonseed, palm kernels, and corn germ. The oleaginous matter is contacted with an organic solvent within the extractor, causing the oil to be extracted from a surrounding cellular structure into the organic solvent. As another example, extractors are used to recover oil from oil sands and other petroleum-rich materials. Typically, the petroleum-rich material is ground into small particles and then passed through an extractor to extract the oil from the solid material into a surrounding organic solvent.

During operation, the selected feedstock is passed through the extractor and contacted with a solvent. The solvent can extract oil out of the feedstock to produce an oil deficient solids discharge and a miscella stream. The miscella stream can contain the solvent used for extraction and oil extracted from the feedstock.

In practice, solvents such as hexane are typically used for extracting oil from oleaginous materials. The oil and/or extracted solid can be used as an intermediate or end product for human and/or animal consumption. While the solvent is removed from the oil and/or extracted solid prior to consumption, consumers are increasingly sensitive about food production processes and standards. Ethanol is alternative solvent to hexane that can be used to separated oil from various oleaginous materials. Ethanol is GRAS (Generally Recognized As Safe), can be produced organically, including from renewable feedstocks, and is already accepted by the consuming public as a component of alcoholic beverages.

### SUMMARY

In general, this disclosure is directed to devices, systems, and techniques, for processing an oil-containing material with an alcohol-based solvent to extract oil from the material. In some examples, a system includes an extractor configured to process an oil-containing feedstock. The extractor receives the oil-containing feedstock and conveys the material from an inlet to an outlet through the extractor. The extractor also receives an alcohol-based solvent at a solvent inlet and conveys the solvent through the extractor to a solvent outlet. The alcohol-based solvent may travel in a countercurrent direction through the extractor from a direction of material travel that the feedstock travels through the extractor. In either case, a concentration of oil in the feedstock may decrease as the feedstock moves through the extractor from the inlet to the outlet. Similarly, the concentration of oil in the solvent may increase as the solvent moves through the extractor from the solvent inlet to the solvent outlet.

The solvent stream containing extracted oil from the feedstock is referred to as miscella. The miscella can be processed to separate the solvent from the extracted oil. Various systems and techniques can be implemented according to the disclosure to help efficiently separate and recover solvent from a miscella stream generated during extraction, promoting efficient operation of the extractor system. For example, during operation, an extraction system can utilize an extractor to generate an oil-containing solvent stream called the miscella and an oil-deficient solids stream carrying entrained solvent called a marc. To separate the oil from the solvent in the miscella stream, the miscella stream may be cooled to a temperature effective to cause phase separation between the aqueous solvent and the oil in the stream. The solvent-rich phase and the oil-rich phase formed via cooling can then be separated, e.g., using a decanter. This can produce a separated oil-rich stream and a separated solvent-rich stream. In the case of a decanter or other phase separation device, a light phase that can be the solvent-rich phase can be separated from a heavy phase that can be the oil-rich phase. Some or all of the light phase can be recycled back to the extractor.

In some implementations according to disclosure, some or all of the light phase recycle stream passes through a separation device that functions as a solvent purification device (e.g., separating residual oil in the light phase from the solvent in the light phase). Example separation devices include membranes (e.g., a nanofiltration membrane) and thermal separators (e.g., an evaporator), with membrane separation devices having particular efficacy in commercial practice. The separation device can separate the light phase recycle stream into a purified solvent stream. The purified solvent stream can be a stream containing solvent that is substantially or completely free of oil and may be referred to as a concentrated solvent stream. The concentrated light phase stream may contain all or substantially all of the oil from the original light phase recycle feed stream. The concentrated light phase stream may be substantially composed of the oil although may also contain a portion of the solvent from the feed stream. The concentrated light phase stream composed predominantly of oil may be referred to as a separated oil stream.

In accordance with some examples of the disclosure, some or all of the concentrated solvent stream generated by the separation device may be recycled back to the extractor, directly or indirectly, to supplement the fresh solvent fed to the extractor. In some examples, the concentrated solvent stream is supplied, directly or indirectly, to the fresh solvent inlet of the extractor. In other examples, the concentrated solvent stream is supplied to a different solvent inlet of the extractor than the fresh solvent inlet.

The separated oil stream generated by the separation device can be processed in a variety of different ways. In some examples, some or all of the separated oil stream is introduced back into the extractor (e.g., at a location where the ratio of oil to solvent in miscella in the extractor is substantially equal to the ratio of oil to solvent and a separated oil stream). Additionally or alternatively, the separated oil stream may be delivered to one or more downstream processing units to further remove the residual solvent from the separated oil stream. In some such applications, the separated oil stream may be combined, directly or indirectly, with an oil-rich heavy phase generated from the decanter or other phase separation device from which the light phase stream was original generated. The two streams, individually or combined, may be sent to a downstream thermal treatment device, such as an evaporator, to vaporize residual solvent for recovery of both the solvent and extracted oil.

In one example, a method is described that includes introducing a solvent into a fresh solvent inlet of an extractor and introducing a material to be processed into a feed inlet of the extractor. The method includes conveying the material to be processed in a conveyance direction through the extractor and conveying the solvent in a countercurrent direction from the conveyance direction through the extractor, thereby generating an extracted material stream and a miscella stream. The example method also includes separating the miscella stream into a solvent-rich stream and an oil-rich stream, introducing the solvent-rich stream into a separation device to generate a concentrated solvent stream and a separated oil stream, and supplying the concentrated solvent stream to the extractor.

In another example, a method is described that includes introducing a solvent comprising alcohol into a fresh solvent inlet of an extractor and introducing a material to be processed into a feed inlet of the extractor. The method includes conveying the material to be processed in a conveyance direction through the extractor and conveying the solvent in a countercurrent direction from the conveyance direction through the extractor, thereby generating an extracted material stream and a miscella stream. The method also includes separating the miscella stream into a solvent-rich stream and an oil-rich stream and contacting a membrane with the solvent-rich stream to form a permeate stream and a retentate stream. The method further involves supplying the permeate stream to the extractor.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example extractor system according to the disclosure.

FIG. 2 is an illustration of an example extractor configuration that can be used in the system of FIG. 1.

FIG. 3 is graph illustrating an example oil content of liquid carried out of an extractor after different numbers of wash stages and at different solvent-carryover ratios

FIG. 4 is a graph illustrating a representative dependence of miscella strength and solvent in miscella on solvent-carryover ratio.

FIG. 5 illustrates an example representative relationship between solvent-carryover and solvent-feed ratio for an extractor.

### DETAILED DESCRIPTION

In general, the disclosure relates to liquid-solid extractor systems and processes that enable the extraction of one or more desired products from solid material flows. In some examples, the solid material is processed in a continuous flow extractor that conveys a continuous flow of material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. The amount of time the solid material remains in contact with the solvent within the extractor (which may also be referred to as residence time) can vary, for example depending on the material being processed and the operating characteristics of the extractor, although will typically be within the range of 15 minutes to 3 hours, such as from 1 hour to 2 hours.

The solvent discharged from the extractor, which may be referred to as a miscella, contains extracted components (e.g., oil, carbohydrates, sugars) from the solid feedstock. The solvent-wet solid material discharged from the extractor may be residual solid feedstock having undergone extraction. In some configurations according to the present disclosure, a miscella stream produced from an extractor is processed to separate the solvent present in the miscella stream from the oil present in the miscella stream. In one configuration, for example, the miscella stream is received from the extractor and cooled to a temperature effective to cause liquid-liquid phase separation between the aqueous and oil components of the miscella stream. For example, the miscella stream may be cooled to a temperature low enough to cause liquid-liquid phase separation but high enough to substantially prevent solidification of either the aqueous or oil components in the stream. In either case, the phase-separated aqueous and oil components of the miscella stream can be separated for further processing and/or recycle, as described herein.

In some examples, a decanter or other gravity separation device is used to separate the miscella into a solvent-rich phase and the oil-rich phase. The oil-rich phase can be supplied for downstream processing, such as to a thermal separation device (e.g., an evaporator) where residual solvent in the oil-rich phase is vaporized from the oil. Some or all of the solvent-rich phase can be recycled back to the extractor. Rather than delivering the solvent-rich phase directly back to the extractor, the solvent-rich phase can be further processed to concentrate the solvent and oil, respectively, in the solvent-rich phase into two different concentrate streams. The resulting concentrated solvent stream can be supplied to the extractor, for example directly or indirectly to a fresh solvent inlet of the extractor. The resulting separated oil stream may be supplied to a downstream location of the extractor (e.g., downstream of the fresh solvent inlet in a direction of solvent conveyance) or may not be supplied to extractor and, instead, may be supplied for downstream processing. For example, the separated oil stream may be sent to a thermal separation device used to process the oil-rich phase generated by the decanter or other gravity separation device.

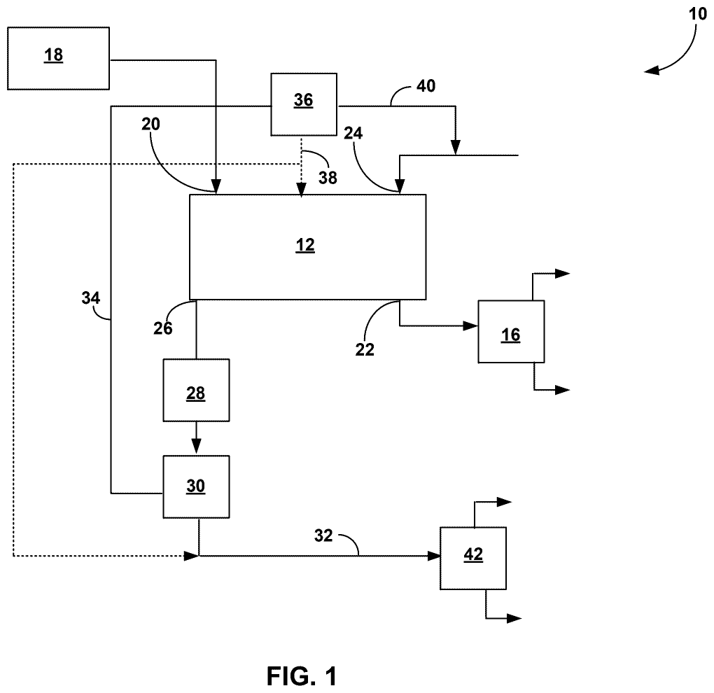

FIG. 1 is a block diagram illustrating an example extraction system 10 according to the disclosure in which a solid material is extracted. System 10 includes an extractor 12 and a desolventizer 16. System 10 is also illustrated as including a dryer 18 upstream of extractor 12. Extractor 12 has a feed inlet 20 that can receive a solid material after having undergone optional drying in dryer 18 to be subject to extraction within the extractor. Extractor 12 also has a feed outlet 22 that can discharge the solid particulate material after is has undergone extraction and has a lower concentration of extract than the fresh incoming material. Extractor 12 also has a solvent inlet 24 configured to introduce fresh solvent into the extractor and a solvent outlet 26 configured to discharge a miscella formed via extraction of extractable components from the solid material.

In operation, the solid material being processed is contacted with solvent within extractor 12 (e.g., in counter current fashion), causing components soluble within the solvent to be extracted from the solid material into the solvent. Extractor 12 can process any desired solid material using any suitable extraction fluid. Example types of solid material that can be processed using extractor 12 include, but are not limited to, oleaginous matter, such as soybeans, rapeseed, sunflower seed, peanuts, cottonseed, palm kernels, and corn germ; oil-bearing seeds and fruits; asphalt-containing materials (e.g., asphalt-containing roofing shingles that include an aggregate material such as crushed mineral rock, asphalt, and a fiber reinforcing); alfalfa; almond hulls; anchovy meals; bark; coffee beans and/or grounds, carrots; chicken parts; diatomic pellets; fish meal; hops; oats; pine needles; tar sands; vanilla; and wood chips and/or pulp.

Alcohol-based solvents that can be used for extraction from solid material include, but are not limited to, mono-hydroxyl or multi-hydroxyl (e.g., di-hydroxyl) alcohols having carbon chains 1 to 8 carbons in length, such as 1 to 4 carbons in length, or 2 to 3 carbons in length. For example, the alcohol-based solvent may be ethanol or isopropyl alcohol. In some examples, the alcohol-based solvent consists essentially of alcohol (e.g., with or without water). For example, the alcohol-based solvent may be a hydrous alcohol or an anhydrous alcohol solvent. In some examples, the alcohol-based solvent has greater than 90 weight percent alcohol and less than 10 weight percent water, such as greater than 95 weight percent alcohol and less than 5 weight percent water, or greater than 98 weight percent alcohol and less than 5 weight percent water. In some applications, the alcohol is ethanol.

In some implementations, the solid material is dried by dryer 18 before being extracted in extractor 12. Dryer 18 can reduce the amount of water in the solid material supplied to extractor 12. When using an alcohol-based solvent, the water content of the solid material introduced into the extractor may be controlled to prevent excess water from entering the extractor, which can dilute the solvent (e.g., reducing the effectiveness of the extraction and/or making solvent recovery challenging). When used, dryer 18 may dry the solid material at a temperature greater than 30° C., such as greater than 50° C., or greater than 60° C., greater than 70° C., greater than 80° C., or greater than 100° C. Additionally alternatively, dryer 18 may dry the solid material at a temperature less than 125° C., such as less than 100° C., or less than 80° C. For example, dryer 18 may dry the solid material at a temperature below the boiling point of water. In some examples, dryer 18 may dry the solid material at a temperature ranging from 40° C. to 90° C., such as from 50° C. to 80° C. Dryer 18 may typically operate at atmospheric pressure although, in other examples, may be configured to operate at a non-atmospheric pressure (e.g., vacuum pressure, positive pressure).

Extractor 12 can produce a solvent-wet solids stream that discharges through feed outlet 22 and a miscella stream that discharges through solvent outlet 26. The miscella stream may be further processed separate the solvent from the oil, as discussed in greater detail below. To recover solvent from the solvent-wet solids stream and further prepare the residual solids material for end use, the solvent-wet solids stream may be desolventized using mechanical and/or thermal desolventization devices. In the example of FIG. 1, system 10 includes a desolventizer 16. Desolventizer 16 can be implemented using one or more stages of mechanical and/or thermal treatment to remove solvent from the solvent-wet solids stream, thereby producing a dried extracted solid material (which may also be referred to as a desolventized extracted solid material). It should be appreciated that reference to a dried and/or desolventized solid material refers to a material that is comparatively dried and desolventized and does not require complete drying or desolventization or that the material be devoid of solvent. Rather, the material may be dried and desolventized to a practical level effective for downstream use and/or processing.

In some examples, desolventizer 16 heats the extracted solid material (the solvent-wet solids stream) produced by extractor 12 to vaporize solvent from the stream to produce a dried solid material. While desolventizer 16 may inject steam into the extracted solid material in some implementations, in other implementations, desolventizer 16 may desolventize the extracted solid material without adding moisture to the material during desolventizing. For example, desolventizer 16 may directly and/or indirectly heat the extracted solid material without injecting steam into the extracted solid material. Desolventizer 16 may indirectly heat the extracted solid material by passing a heat transfer fluid through a tray that the extracted material contacts while passing through a desolventizing vessel and/or through a jacket surrounding at least a portion of the desolventizing vessel. Additionally or alternatively, desolventizer 16 may introduce a heated gas substantially devoid of moisture (e.g., dried air, nitrogen) into an interior of the desolventizing vessel and extracted solid material therein.

In different examples, desolventizer 16 can be implemented using a cooker, jacketed paddle mixer, bulk solids heat exchanger, and/or desolventizer-toaster. In any case, the solvent separated from the solvent-wet extracted solids stream via desolventizer 16 can be recycled back to extractor 12 for reuse (optionally with further processing, such as to decrease the water content in the solvent stream, before being returned to the extractor).

As noted above, extractor 12 produces a miscella stream that discharges through solvent outlet 26. This miscella stream can be further processed to help separate the oil faction of the miscella stream from the solvent fraction. In the example of FIG. 1, system 10 includes a cooling unit 28 that is configured to receive the miscella stream and cool the stream to promote liquid-liquid phase separation between the aqueous alcohol-based solvent component of the miscella and the extracted oil component of the miscella. Cooling unit 28 may be implemented using one or more heat exchangers or other thermal transfer devices that reduce a temperature of the miscella stream to a temperature effective to cause phase separation. In some examples, cooling unit 28 cools the miscella stream to a temperature less than 40 degrees Celsius, such as less than 30 degrees Celsius, or less than 25 degrees Celsius (e.g., a temperature ranging from 15 degrees Celsius to 25 degrees Celsius, such as approximately 20 degrees Celsius). In other examples, extractor system 10 is implemented without cooling unit 28, and it should be that FIG. 1 is merely one configuration of an example system that can be implemented according to the disclosure.

By contrast, the operating temperature of extractor 12 may be sufficiently hot to produce a miscella stream discharging from the extractor at a temperature greater than 50 degrees Celsius, such as greater than 60 degrees Celsius, or greater than 65 degrees Celsius. For example, the temperature of the miscella stream received from the extractor may range from 60 degrees Celsius to 90 degrees Celsius, such as from 65 degrees Celsius to 80 degrees Celsius, such as approximately 70 degrees Celsius.

Cooling the miscella stream can produce a solvent-rich phase separated from an oil-rich phase. A compositional gradient may exist between the solvent-rich phase and the oil-rich phase formed by cooling the miscella stream. In either case, in the example of FIG. 1, extraction system 10 includes a separator 30 to separate the solvent-rich phase from the oil-rich phase. The solvent-rich phase may be referred to as a light phase, while the oil-rich phase may be referred to as a heavy phase. Separator 30 may be implemented using a decanter (e.g., gravity decanter) and/or other liquid separation device, such as a centrifuge and/or cyclone. Separator 30 can separate the solvent-rich phase from the oil-rich phase to produce a separated oil-rich stream/heavy phase stream 32 and a separated solvent-rich stream/light phase 34. The two separate streams may be recycled and/or further processed.

For example, with reference to FIG. 1, some or all of the solvent-rich stream 34 generated by separator 30 may be further processed with a secondary separation device 36 to further purify the solvent in the solvent-rich stream for recycle to extractor 12. Secondary separation device 36 can produce a separated oil stream 38 and a concentrated solvent stream 40. In some examples, secondary separation device 36 is implemented as a thermal separator. For example, secondary separation device 36 may be an evaporator with condenser. The evaporator can evaporate solvent from solvent-rich stream 34 that is then condensed, resulting in substantially purified solvent stream 40 and a residual separated oil stream 38 (which can contain a residual solvent fraction from the incoming feed stream).

In other examples, secondary separation device 36 may be implemented using a membrane, such as a nanofiltration membrane. The solvent-rich stream 34 can be provided as a feed stream to the membrane, with the feed stream contacting the membrane and generating a permeate stream and a retentate stream through membrane separation. The permanent stream generated by the membrane provides concentrated solvent stream 40. The retentate stream generated by the membrane provides separated oil stream 38.

The concentrated solvent stream 40 can be supplied back to extractor 12 directly (e.g., by being supplied to a solvent inlet of the extractor) or indirectly (e.g., by being supplied to a solvent tank which, in turn, supplies solvent to the extractor). In some examples, concentrated solvent stream 40 may be recycled, directly or indirectly, back to the fresh solvent inlet 24 of extractor 12. In other examples, concentrated solvent stream 40 may be recycled, directly or indirectly, back to a different solvent inlet of extractor 12 (e.g., to a downstream extraction stage in a direction of solvent flow). For example, the concentrated solvent stream 40 may be recycled back to extractor 12 and introduced into the extractor at a location where a composition of miscella in the extractor is substantially the same as a composition of the concentrated solvent stream. For example, the concentration of the solvent in the concentrated solvent stream 40 (e.g., calculated by dividing the weight of the alcohol and water by the combined weight of the alcohol, water, and oil) may be within ±20 weight percent of the concentration of the solvent in the miscella in the extraction stage of the extractor to which the concentrated solvent stream is recycled, such as within ±10 weight percent, or within ±5 weight percent. Additionally or alternatively, the concentration of the oil in the concentrated solvent stream 40 (e.g., calculated by dividing the weight of the oil by the combined weight of the alcohol, water, and oil) may be within ±20 weight percent of the concentration of the oil in the miscella in the extraction stage of the extractor to which the concentrated solvent stream is recycled, such as within ±10 weight percent, or within ±5 weight percent.

Concentrated solvent stream 40 generated by secondary separator 36 may be substantially pure solvent (e.g., substantially devoid of oil). In some examples, the concentrated solvent stream 40 generated by secondary separator 36 may have greater than 90 weight percent alcohol and less than 10 weight percent oil, such as greater than 95 weight percent alcohol and less than 5 weight percent oil, or greater than 98 weight percent alcohol and less than 2 weight percent oil.

As briefly noted above, the oil-rich stream/heavy phase stream 32 generated by separated 30 can be further processed. In the example of FIG. 1, extraction system 10 includes thermal separator 42. Thermal separator 42 can receive some or all of oil-rich stream 32 and/or separated oil stream 38 produced by secondary separator 36 to remove residual solvent from one or both streams. Thermal separator 42 can be implemented using a stripping column (e.g., that utilizes steam or other motive gas), a distillation column, a flash drum, an evaporator, and/or other thermal separation device. In either case, the solvent separated from the separated via thermal separator 42 can be recycled, directly or indirectly, back to solvent inlet 24 of extractor 12 for reuse.

Separated oil stream 38 produced by secondary separator 36 can be recycled and/or further processed. In some examples, some or all of separated oil stream 38 generated by secondary separator is recycled back to extractor 12. In these examples, the separated oil stream 38 can be recycled to a different stage of the extractor than a stage where concentrated solvent stream 40 is recycled. For example, separated oil stream 38 can be recycled to a downstream extraction stage of extractor 12 (downstream in a direction of solvent travel) compared to a stage where concentrated solvent stream 40 is recycled. For example, separated oil stream 38 can be recycled and introduced at least one, two, three, four, five, or more stages downstream (in a direction of solvent travel) from the stage where concentrated solvent stream 40 is recycled (which may be the fresh solvent inlet/first stage of the extractor in the direction of solvent travel or final stage of the extractor in the direction of material travel).

In some examples, the separated oil stream 38 may be recycled back to extractor 12 and introduced into the extractor at a location where a composition of miscella in the extractor is substantially the same as a composition of the separated oil stream 38. For example, the concentration of the oil in the separated oil stream 38 (e.g., calculated by dividing the weight of the oil by the combined weight of the alcohol, water, and oil) may be within ±40 weight percent of the concentration of the oil in the miscella in the extraction stage of the extractor to which the separated oil stream is recycled, such as within ±20 weight percent, within ±10 weight percent, or within ±5 weight percent

Additionally or alternatively, some or all of separated oil stream 38 may be sent to downstream processing instead of being recycled back to extractor 12. For example, some or all of separated oil stream 38 may be supplied to thermal separator 38, which also received and processes some or all of oil-rich stream 32. Thermal separator can vaporize residual solvent from the separated oil stream, for solvent recovery and reuse as well as recovery of extracted oil.

Extractor 12 in any of the foregoing examples can be implemented using any suitable type of extractor configuration. For example, extractor 12 may be an immersion extractor, a percolation extractor, or yet other type of extractor design. In one example, extractor 12 is a shallow bed continuous loop extractor.

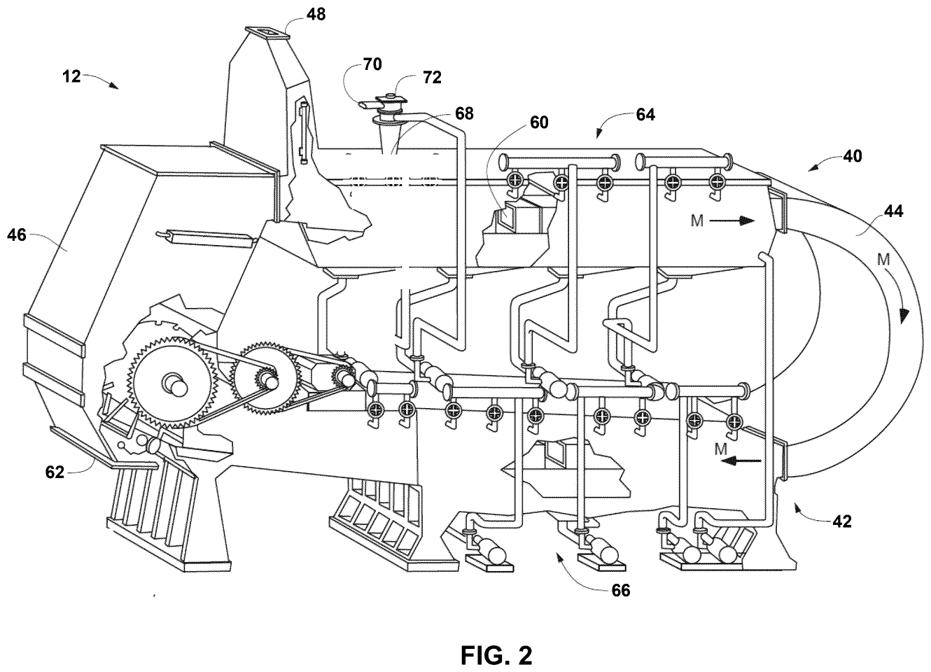

FIG. 2 is an illustration of an example extractor configuration that can be used for extractor 12. In the example shown, extractor 12 includes a housing defining a passageway in the form of a loop disposed in a vertical plane. The extractor can include upper and lower extraction sections 40, 42 each with a series of extraction chambers, a generally arcuate hollow transfer section 44 having its opposite upper and lower ends connected to first ends of the upper and lower extraction sections respectively, and a hollow, generally vertical return section 46 connected at its upper and lower ends respectively to the other ends of the upper and lower extraction sections. The upper extraction section can include an inlet portion 48 for delivery of solid material to the interior thereof in closely spaced relation to the upper end of the return section, and the lower end of the return section can define an opening 62 for discharge of the material after the product-of-interest has been extracted therefrom. The number of extraction chambers, or stages, provided by the extractor can vary depending on the desired sized of the extractor. The extractor includes at least one extraction chamber, or stage, and typically includes multiple stages (e.g., 6 stages, 8 stages, or more). A Model III extractor commercially available from Crown Iron Works Company of Minneapolis, MN, is a specific example of an extractor of this type.

In such an extractor, a conveyor system 60 can extend longitudinally through the looped passageway and be driven in a material flow direction “M” to move the material as a bed from the inlet portion 48 through the upper extraction section 40 toward and downwardly through the transfer section 44, and through the lower extraction section 42 toward the lower end of the return section and the discharge opening 62. In some embodiments, the conveyor system includes a pair of laterally spaced endless link chains and a plurality of longitudinally spaced flights that extend transversely of the chains. A motor and gearing may be provided to drive the conveyor.

In some configurations, a fluid supply system 64 can be disposed above the solid materials and configured to apply a fluid to the solid materials in each extraction chamber, and a fluid removal system 66 can be disposed below the solid materials and configured for removing the fluid after it has passed through the solid materials in each extraction chamber. In some embodiments, the fluid supply system and the fluid removal system are in fluid communication via various recycle streams and the like. The fluid supply system may include a network of spray headers, pumps, and pipes to apply the fluid in each extraction chamber. The fluid supply system can apply (e.g., spray) the extraction fluid on top of the conveyed solid material, allowing the extraction fluid to then percolate through the material. The fluid removal system may include a network of drains, pumps, and pipes to collect the fluid after it has percolated through the solid material in each extraction chamber and deliver it to the fluid supply system of another extraction chamber or remove it from the system.

As shown in FIG. 2, fluid having passed through the solid material is collected by the fluid removal system 66 and delivered to a separation device 68, which in the illustrated example is shown as a cyclone-type separator to separate any solid fines from the fluid before fluid discharge. An outlet conduit 70 of separation device 68 can deliver the fluid, generally a mixture of extraction fluid and soluble components extracted from the solid material into the extraction fluid (e.g., oil when processing oil seed) (commonly known as “miscella”), to other equipment, not shown, for separating the extraction fluid from the material extracted from the solid material being processed. A separate outlet 72 of separation device 68 can deliver a stream containing particulate matter separated from the miscella.

As material is conveyed through extractor 12, spray headers from the fluid supply system 64 spray recycled extraction fluid on the top of the material. The material percolates through the material and through the screen, where it is collected in the network of drain pipes and delivered back to the network of spray headers where it is reapplied to the solid material in a different extraction chamber. In some embodiments, fresh extraction fluid is applied to the material in the last extraction chamber before the solid material discharge 62. For example, fresh extraction fluid may be applied to the material in the last extraction chamber before discharge 62 and, after being collected at the bottom of the chamber, recycled and applied on top of solid material in an adjacent upstream extraction chamber. By recycling collected extraction fluid from one extraction chamber to an adjacent upstream extraction chamber, liquid extraction fluid and solid material being processed can move in countercurrent directions through the extractor. For example, as extraction fluid is conveyed sequentially through adjacent extraction chambers between a fresh extraction fluid inlet adjacent discharge 62 and an enriched extraction fluid outlet adjacent inlet 48, the concentration of extract relative to extraction fluid increases from a relatively small extract-to-extraction fluid ratio to a comparatively large extract-to-extraction fluid ratio. Similarly, as the solid material is conveyed in the opposing direction, the concentration of extract in the solid feedstock decreases from a comparatively high concentration at the inlet 48 to a comparatively low concentration at the outlet 62.

Configuring an extraction system, such as extraction system 10, with separation device 36, such as a membrane separator, can provide a variety of operational and performance advantages. In some examples, such a configuration can allow extractor 12 to be operated at a high solvent ratio. This can reduce the amount of residence time the solid material needs to be processed in extractor 12 to achieve the same level of oil removal as compared to operating at a lower recycle ratio.

In operation, liquid flows and solid flows can move through multi-stages in countercurrent flow in extractor 12. Within extractor 12, the solids carry some liquid with them as they travel from stage to stage, which is referred to as carried solvent and contains both solvent and oil in varying proportions across the various extractor stages. Excess liquid beyond the amount carried by the solids flows in the opposite direction to the solids and is referred to as the net forward solvent, which again contains both solvent and oil in varying proportions in different stages. The net forward solvent flow can contain almost all of the oil when it exits the first flake stage, which is the miscella discharged from miscella outlet 26.

The different stages of extractor 12 may be divided into extraction stages (collectively forming an extraction zone) and wash stages (collectively forming a wash zone). The extraction zone are the stages in which the kinetic process of oil extraction occurs. After the kinetics-governed process is substantially complete, extraction becomes a diffusive exchange of liquid between the interstitial pores within the solid material and the bulk liquid flowing around it. The stages in which this diffusive transfer mechanism governs oil removal is the wash zone. The theoretical limit for oil extraction performance in each wash zone stage is complete equilibration of oil content in the liquid contained in the solid material and the bulk liquid.

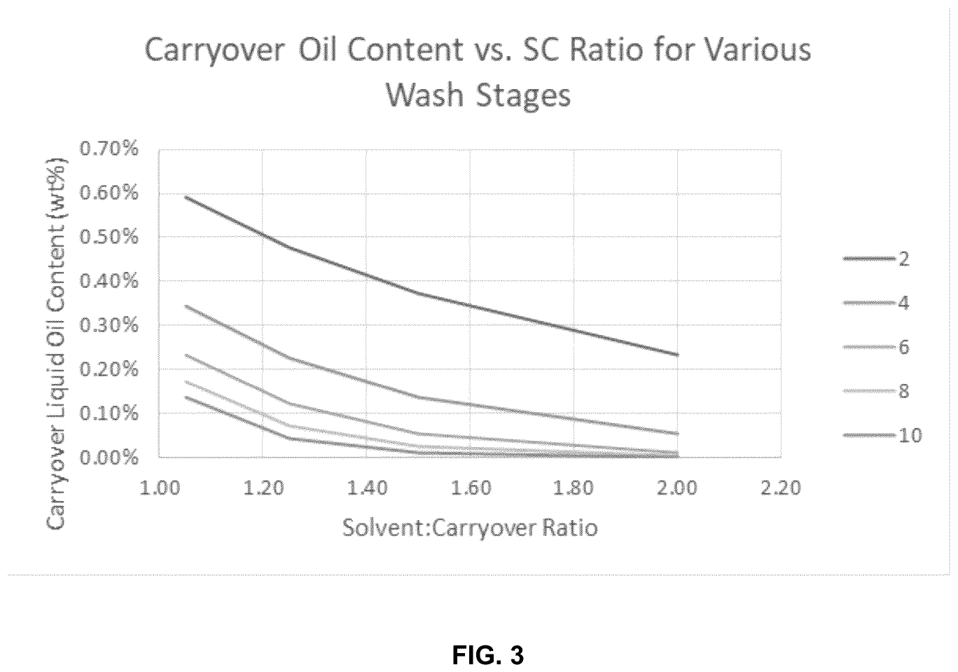

The ratio of lower-oil net forward solvent to higher-oil carried solvent flow rates determines the equilibrium oil content in the liquid leaving a stage (both net forward and carried). FIG. 3 is graph illustrating example oil content of the liquid carried out of an extractor after different numbers of wash stages and at different solvent:carryover ratios (“SC ratio”), which is the ratio of the flow rate of fresh solvent into the extractor to the flow rate of liquid carried by the flakes out of the extractor. At an SC ratio of 1.0, all fresh solvent is carried out with the extracted flakes. The net forward solvent flow thus drops to zero, at which point no washing occurs. As the SC ratio increases, oil in the carryover liquid goes down. This allows either lower residual oil for a given number of wash zone stages, or a constant residual oil with fewer wash zone stages.

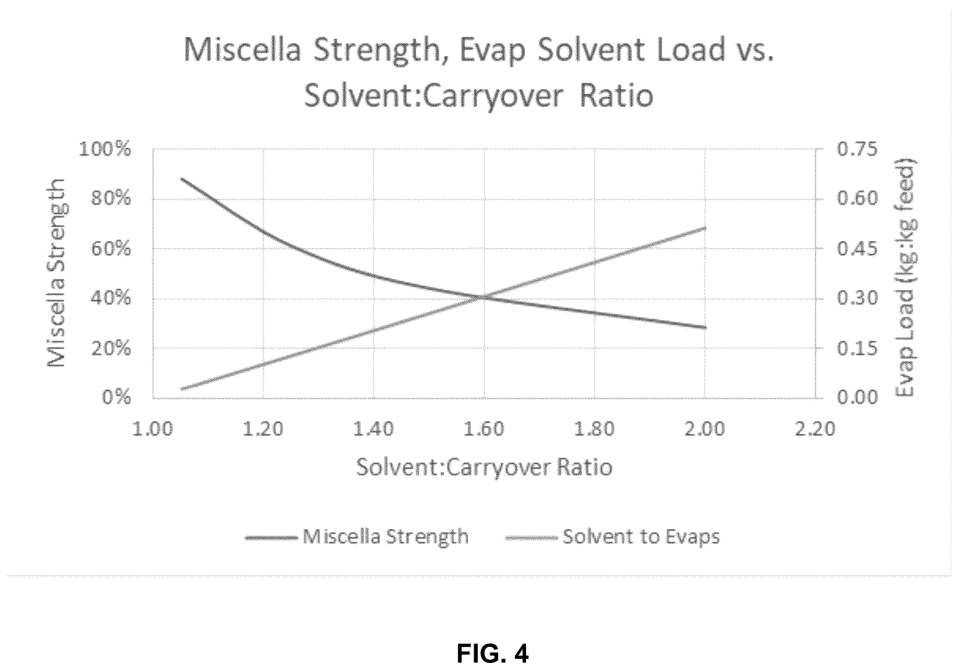

Excess solvent beyond that carried by the extracted flakes travels forward with the oil and leaves in the miscella supplied to separator 30. This solvent can then be recovered, typically via evaporation or other thermal separation, which uses energy. The SC ratio thus presents a tradeoff between oil extraction performance and energy usage. FIG. 4 is a graph illustrating a representative dependence of miscella strength (wt % oil) and solvent in miscella (kg/kg solid feed to extractor) on SC ratio. As the SC ratio goes up, the miscella strength drops and the energy usage for thermal separation increases.

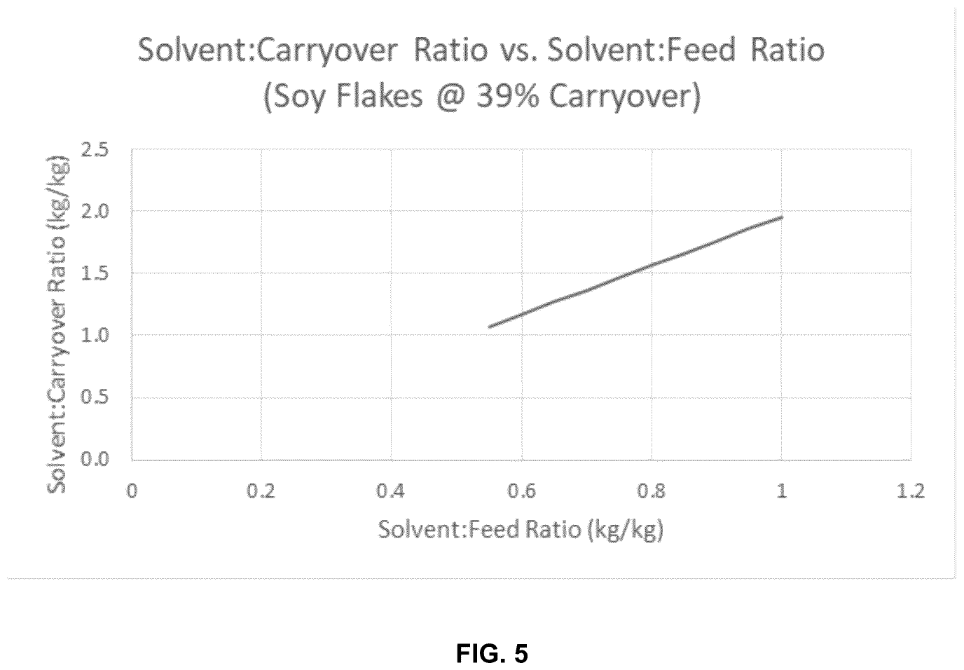

The solvent rate to extractor 12 is typically expressed as the ratio of fresh solvent to solid feed (“SF ratio”). The SF ratio, together with the extracted flake carryover, determines the SC ratio. FIG. 5 illustrates an example representative relationship between SC and SF ratio based on soy flakes at 39% carryover.

By configuring extraction system 10 with secondary separation device 36 as discussed herein, the tradeoff between oil extraction performance and energy can be reduced or eliminated by making the SC ratio independent of the SF ratio. The configuration allows a low solvent:feed ratio that substantially balances the solvent carried out in the extracted flakes and in to the separator 30 (minimizing energy usage for thermal separator 42), while providing the wash section with a much higher solvent:carryover ratio (increasing extraction performance or decreasing the required number of wash stages). In this way, real world operational benefits and performance improvements are provided by systems and techniques in accordance with the disclosure.

In some applications, extractor 12 is operated at a solvent:feed ratio (weight of solvent divided by the weight of feed) less than 1.5, such as less than 1.2, less than 1.0, less than 0.9, less than 0.8, less than 0.7, less than 0.6, or less than 0.5. For example, extractor 12 may be operated at a solvent:feed ratio within a range from 0.5 to 1.0, such as from 0.6 to 0.9. Additionally or alternatively, extractor 12 may be operated at a solvent:carryover ratio (at least in the wash section) greater than 1.0, such as greater than 1.2, greater than 1.3, greater than 1.4, greater than 1.5, greater than 1.6, greater than 1.7, greater than 1.8, greater than 1.9, or greater than 2.0. For example, extractor 12 may be operated at a solvent:carryover ratio (at least in the wash section) within a range from 1.4 to 2.4, such as from 1.5 to 2.2, or from 1.6 to 2.0.

Various examples have been described. These and other examples are within the scope of the following claims.

1. A method comprising:
introducing a solvent comprising alcohol into a fresh solvent inlet of an extractor and introducing a material to be processed into a feed inlet of the extractor;
conveying the material to be processed in a conveyance direction through the extractor and conveying the solvent in a countercurrent direction from the conveyance direction through the extractor, thereby generating an extracted material stream and a miscella stream;
separating the miscella stream into a solvent-rich stream and an oil-rich stream;
introducing the solvent-rich stream into a separation device to generate a concentrated solvent stream and a separated oil stream; and
supplying the concentrated solvent stream to the extractor.

2. The method of claim 1, wherein:
the separation device comprises a membrane; and
introducing the solvent-rich stream into the separation device to generate the concentrated solvent stream and the separated oil stream comprises contacting the membrane with the solvent-rich stream to generate a permeate stream that is the concentrated solvent stream and a retentate stream that is the separated oil stream.

3. The method of claim 1, wherein the separation device comprises an evaporator and a condenser.

4. The method of claim 1, wherein supplying the concentrated solvent stream to the extractor comprises supplying the concentrated solvent stream to the fresh solvent inlet of the extractor.

5. The method of claim 1, wherein supplying the concentrated solvent stream to the extractor comprises supplying the concentrated solvent stream to a secondary solvent inlet of the extractor, the secondary solvent inlet of the extractor being located downstream of the fresh solvent inlet in a direction of solvent conveyance through the extractor.

6. The method of claim 1, further comprising supplying the separated oil stream to the extractor.

7. The method of claim 1, further comprising:
introducing the oil-rich stream separated from the miscella stream into a thermal separator;
introducing the separated oil stream generated by the separation device into the thermal separator; and
evaporating, by the thermal separator, solvent from the oil-rich stream and the separated oil stream introduced into the thermal separator.

8. The method of claim 1, wherein separating the miscella stream into the solvent-rich stream and the oil-rich stream comprises gravity separating the miscella stream into the solvent-rich stream and the oil-rich stream.

9. The method of claim 8, wherein separating the miscella stream into the solvent-rich stream and the oil-rich stream comprises comprising cooling the miscella stream to form a solvent-rich phase and an oil-rich phase, and decanting the solvent-rich phase from the oil-rich phase.

10. The method of claim 1, wherein the solvent supplied to the fresh solvent inlet and the concentrated solvent stream supplied to the fresh solvent inlet each comprises greater than 90 weight percent alcohol and less than 10 weight percent oil.

11. The method of claim 1, wherein the alcohol comprises ethanol.

12. A method comprising:
introducing a solvent comprising alcohol into a fresh solvent inlet of an extractor and introducing a material to be processed into a feed inlet of the extractor;
conveying the material to be processed in a conveyance direction through the extractor and conveying the solvent in a countercurrent direction from the conveyance direction through the extractor, thereby generating an extracted material stream and a miscella stream;
separating the miscella stream into a solvent-rich stream and an oil-rich stream;
contacting a membrane with the solvent-rich stream to form a permeate stream and a retentate stream; and
supplying the permeate stream to the extractor.

13. The method of claim 12, where supplying the permeate stream to the extractor comprises supplying the permeate to the fresh solvent inlet of the extractor.

14. The method of claim 12, where supplying the permeate stream to the extractor comprises supplying the permeate a secondary solvent inlet of the extractor, the secondary solvent inlet of the extractor being located downstream of the fresh solvent inlet in a direction of solvent conveyance through the extractor.

15. The method of claim 14, wherein supplying the permeate stream to the secondary solvent inlet of the extractor comprises introducing the permeate stream into the extractor at location where a concentration of solvent in a miscella in the extractor is ±10 weight percent of the concentration of solvent in the permeate stream.

16. The method of claim 12, further comprising introducing the retentate stream into the extractor.

17. The method of claim 12, further comprising:
introducing the oil-rich stream separated from the miscella stream into a thermal separator;
introducing the retentate stream into the thermal separator; and
evaporating, by the thermal separator, solvent from the oil-rich stream and the retentate stream introduced into the thermal separator.

18. The method of claim 12, wherein separating the miscella stream into the solvent-rich stream and the oil-rich stream comprises gravity separating the miscella stream into the solvent-rich stream and the oil-rich stream.

19. The method of claim 18, wherein separating the miscella stream into the solvent-rich stream and the oil-rich stream comprises cooling the miscella stream to form a solvent-rich phase and an oil-rich phase, and decanting the solvent-rich phase from the oil-rich phase.

20. The method of claim 12, wherein the alcohol comprises ethanol.
